(19) United States
(12) Patent Application Publication
(10) Pub. No.: US 2015/0294265 A1
(43) Pub. Date: Oct. 15, 2015

(54) SYSTEMS AND METHODS FOR DELIVERING PACKAGES

(71) Applicant: Dante Monteverde, Las Vegas, NV (US)

(72) Inventor: Dante Monteverde, Las Vegas, NV (US)

(21) Appl. No.: 14/248,856

(22) Filed: Apr. 9, 2014

(51) Int. Cl. G06Q 10/08; G06Q 10/10

(52) U.S. Cl. CPC G06Q 10/0833; G06Q 10/1097

(57) ABSTRACT

Systems and methods in which parcels intended to be delivered to recipients are shipped to a common location and items going to a same address are consolidated into one or more packages and delivered to the recipient in a single shipment/delivery based on a predetermined schedule. The systems and methods also provide for a recipient to return an item. The recipient may enter an address and view an estimated time when a delivery vehicle will be at or near the entered address to pick up the return item.

### FIELD

The present application relates to systems and method for delivering parcels.

### BACKGROUND

Many companies routinely send magazines, catalogs, DVDs, advertising materials, samples of new products, periodicals, etc. to recipients. Conventional delivery systems are predicated on delivering these items to each intended recipient on a daily basis, except Sunday generally. However, this daily delivery can be inefficient and costly.

### SUMMARY

The systems and methods disclosed herein relate to a many-to-one parcel/mail delivery technique. Many companies routinely send magazines, catalogs, DVDs, advertising materials, samples of new products, periodicals, etc. to recipients. As disclosed, mail and parcels going to the same address are shipped to a common location and items going to the same address are consolidated into one or more packages and delivered to the recipient in a single shipment/delivery. The consolidated package may be delivered weekly, monthly, etc. This allows delivery to occur at a fraction of the cost, without wasting the resources that it takes to make multiple trips to the same address.

In an aspect, a method for delivering items is disclosed that includes receiving a plurality of items from one or more sending entities, identifying addresses of intended recipients of the items, and creating a package containing more than one item intended to be delivered to a same address. The packages are then simultaneously delivered to the intended recipients on a weekly or monthly basis.

In another aspect, a system is disclosed including a server in communication with a network, the server including at least one processor and a memory device including instructions operable to be executed by the at least one processor to perform a set of actions. The processor is configured to identify addresses of intended recipients of items received from sending entities, determine a number of items to be delivered to a same address, and determine a number of identical packages to create, each containing items to be delivered to a respective address. The processor is also configured to track a delivery vehicle along a delivery route, receive an address input from a recipient desiring to return an item, and allow the recipient to view when the delivery vehicle will be at or near the input address to pick up the return item.

### BRIEF DESCRIPTION OF THE DRAWINGS

Embodiments of devices, systems, and methods are illustrated in the figures of the accompanying drawings which are meant to be exemplary and not limiting, in which like references are intended to refer to like or corresponding parts, and in which:

FIG. 1 illustrates an exemplary overview of a system and method for consolidating and delivering parcels according to aspects of the disclosure;

FIG. 2 is a block diagram conceptually illustrating a computing device according to aspects of the disclosure;

FIG. 3 illustrates an exemplary method for consolidating and delivering packages according to aspects of the disclosure;

FIG. 4 illustrates an exemplary method for consolidating and delivering packages according to aspects of the disclosure;

FIG. 5 illustrates an exemplary method for delivering packages according to aspects of the disclosure;

FIG. 6 illustrates an exemplary method for allowing a recipient to return a package according to aspects of the disclosure; and

FIG. 7 illustrates an exemplary method of receiving information from sending entities according to aspects of the disclosure.

### DETAILED DESCRIPTION

Detailed embodiments of devices, systems, and methods are disclosed herein, however, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative basis for teaching one skilled in the art to variously employ the present disclosure.

In general, the systems and methods relate to a many-to-one parcel/mail delivery technique. Many companies routinely send magazines, catalogs, DVDs, advertising materials, samples of new products, periodicals, etc. to recipients. In the past, mail and package delivery systems consisted of a single sender mailing a correspondence or a package to a recipient in another physical location using a post office, or a private carrier that delivers to the appropriate recipient address. However, this can be inefficient, requiring the carrier to repeatedly, if not daily, travel to the recipient's address to deliver mail or packages.

A more efficient and sustainable system and method is disclosed in which mail and parcels going to the same address are shipped to a common location and items going to the same address are consolidated into one or more packages and delivered to the recipient in a single shipment/delivery. The consolidated package may be delivered weekly, monthly, etc. This allows delivery to occur at a fraction of the cost, without wasting the resources that it takes to make multiple trips to the same address. This efficiency can also save cost and offer several advantages to returning merchandise.

For example, a manufacturer may desire to ship products to consumers for testing or a trial period. The system and method allows for a period of time, such as, one month or 30 days in advance of the return date, to be programmed into the system. The system may also allow for the location of any vehicle/driver to be predicted or monitored in real time on the return date. After the test or trial period, the system can pinpoint the best point of intersection between the driver and the consumer's/sender's location at any given address for that day, such as a home, a workplace, or restaurant where the driver and the sender can intersect to return the product. The system allows the sender to use a smart phone or tablet, or other computing or communication device to view the location of the driver/vehicle in real time as the driver nears the point of intersection where the transaction can take place, for example, in a parking lot, for maximum efficiency. This system allows a manufacturing company to try/test a new product with a prospective consumer at a fraction of the cost of the existing shipping methods available today.

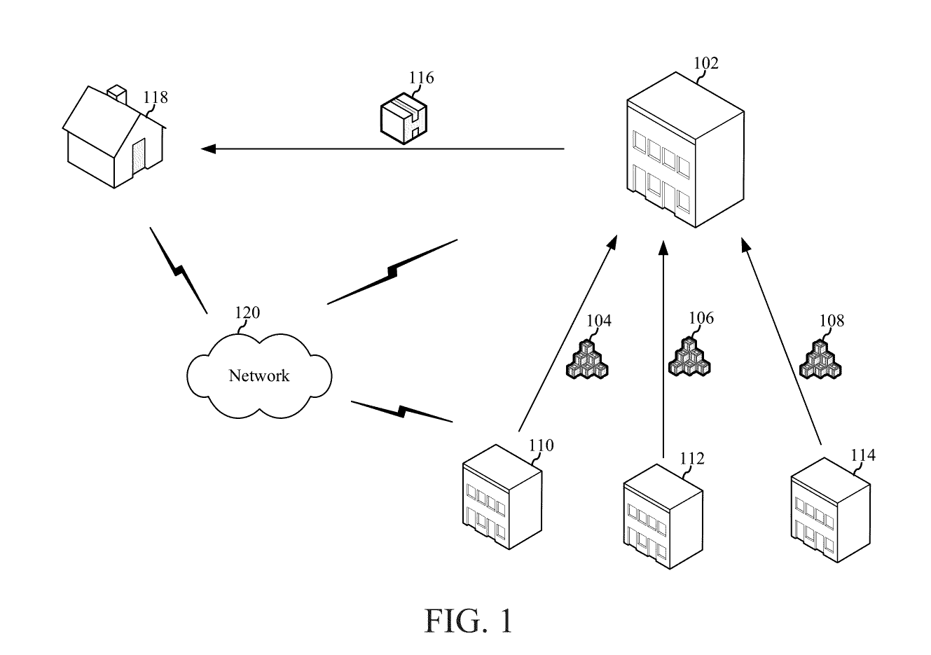

FIG. 1 is an overview of a system and method for consolidating and delivering parcels. As illustrated in FIG. 1, a first entity 102 (also referred to herein as a “delivery company”), receives parcels 104-108 from sending entities 110-114, respectively, such as a merchant, manufacturer, advertising company, financial institution, and other commercial and non-commercial entities. The parcels 104-108 may be items intended for delivery to recipients at respective addresses.

The first entity 102 collects and consolidates a number of items that are intended for delivery to a same address 118 into a single package 116. The first entity may then deliver the package 116 to the address 118 on a predetermined schedule. By consolidating many items into one package to dispatch to each different address, the first entity may only deliver to each address once a week or once a month. Thus, a given address would be visited only once in a month or week instead of every day, saving resources and capital cost.

Typically, all the potential combinations of content are reduced to a finite number of different content boxes that can be nominated from #1 trough X. For example, box type #1 may contain items going to affluent zip codes. Other numbered boxes may have less and less items going to those addresses not subscribing to some of the magazines, etc., or not desirable to certain advertisers.

The system and method may also include a computer program adapted to create a database of all the addresses that require deliveries, and determine how many identical content boxes may be required. The program may also be adapted to predict the weight, delivery time, and location of all resources, such as drivers, vehicles and packages in advance (such as 30 days, 7 days, or the length of the delivery period).

The system and method may allow the first entity 102 to communicate with the sending entities 110-114 and the recipients of the packages 116, and vice versa through a network 120, using computing devices. This allows a sending entity to identify, track, coordinate delivery dates, and communicate information about the parcels being sent to the first entity 102. For example, a sending entity may send a parcel to the first entity that is perishable or should be sent to a recipient within a certain amount of time. In this example, the sending entity can obtain scheduled shipment dates from the first entity 102, and ensure the parcel is received by the first entity 102 and shipped to a recipient within a certain amount of time.

Similarly, using a computing device, a recipient may be able to view scheduled shipment dates of the first entity 102 and delivery vehicle locations. For example, a recipient or sender can enter an address in a browser or portable device and view a date or a time window (such as 10-30 minutes), at what time the delivery vehicle will be at or near the entered address. The delivery vehicles may also be equipped with GPS or other positioning equipment. This may allow the recipient, first entity, or sending entity to view a present location of the delivery vehicle. Thus, a sender or recipient may receive or send a parcel from a home, work, a restaurant or any place that a person intends to be to complete the transaction. As an example, a recipient may receive a product that is intended to be returned after a test or trial period. The system and method can pinpoint the best point of intersection between the driver and the consumer's/sender's location at any given address for that day, such as a home, a workplace, or restaurant where the driver and the sender can intersect to return the product.

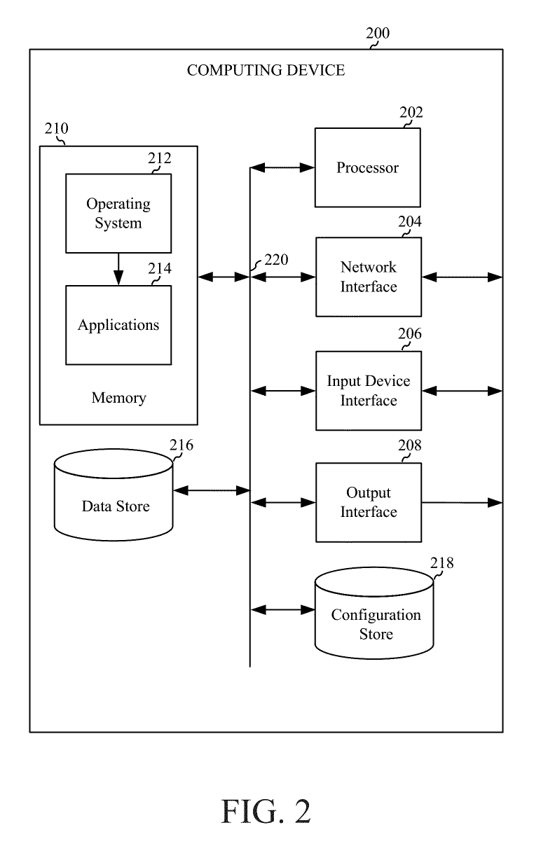

Aspects of the present disclosure may be implemented as a computer implemented method in a computing device or computer system. These computing devices may include, but are not limited to, mobile phones, laptop computers, tablet computers, personal computers, workstations, mini- and mainframe computers, servers, and the like. The general architecture of a suitable computing device is described below with reference to FIG. 2. However, the following description of the exemplary components of a computing device 200 should be viewed as illustrative only and not construed as limiting in any manner.

With regard to FIG. 2, the exemplary computing device 200 may include a processor 202 in communication with a variety of other components over a system bus 220 or through a direct connection. These other components may include, by way of example, a network interface 204, an input device interface 206, an output interface 208, and a memory 210. As appreciated by those skilled in the art, the network interface 204 enables the computing device 200 to communicate data, control messages, data requests, and other information with other resources including computers, data sources, storage devices, and the like, on a computer network such as the Internet. The network interface 204 may be configured to communicate via wired or wireless connections. As one skilled in the art should appreciate, the computing device 200 may obtain scan and identify wireless access points via the computer network or other network.

The input device interface 206, sometimes also embodied as an input/output interface, enables the computing device 200 to obtain data input from a variety of devices including, but not limited to, a microphone, a digital pen, a touch screen, a keyboard, a mouse, a scanner, and the like. In addition to the exemplary components described above, an output interface 208 may be used for outputting information such as signals or display information. Display information may be output by the output interface 208 via a display device (e.g., a monitor or similar device, not shown), for example.

The processor 202 may be configured to operate in accordance with programming instructions stored in a memory 210. The memory 210 generally comprises RAM, ROM, and/or other memory. Thus, in addition to storage in read/write memory (RAM), programming instructions may also be embodied in read-only format, such as those found in ROM or other permanent memory. The memory 210 may store an operating system 212 for controlling the operation of the computing device 200. The operating system may be a general purpose operating system such as a Microsoft Windows operating system, a UNIX operating system, a Linux operating system, or an operating system specifically written for and tailored to the computing device 200. Similarly, the memory 210 may also store user-executable applications 214, or programs, for conducting various functions on the computing device 200. For example, the application 214 in memory 210 may be configured according to aspects of the present disclosure to identify delivery locations, addresses, current vehicle locations, etc.

The computing device 200 may also include a data store 216 and a configuration store 218 adapted to store location data associated with network availability, delivery vehicle locations, and information for identifying delivery routes, etc.

It should also be understood that the following description is presented largely in terms of logic and operations that may be performed by conventional computer components and media components. These computer components, may be grouped in a single location or distributed over a wide area. In circumstances where the computer components are distributed, the components may be accessible to each other via wired and/or wireless communication links, for example.

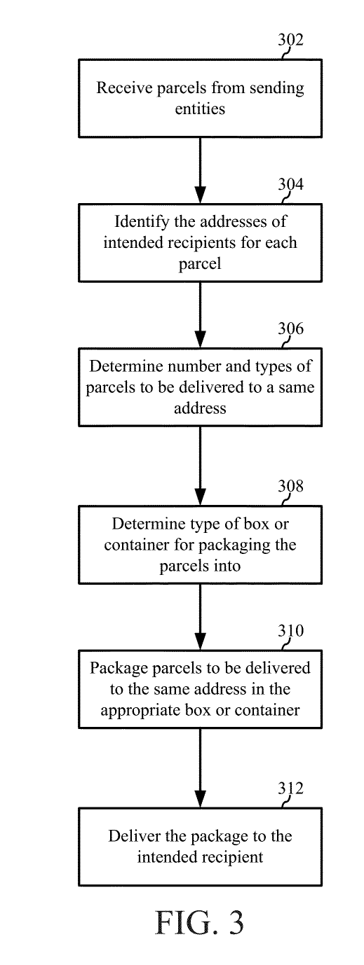

FIG. 3 illustrates an exemplary method for consolidating and delivering packages. One or more of the logical components of FIG. 2 may perform one or more steps of the following methods. In block 302, the first entity receives one or more parcels from one or more sending entities. Addresses of intended recipients of the parcels are identified, illustrated as block 304. In an aspect, a database of all the addresses that require deliveries may be created. A number and types of the parcels to be delivered to a same address are identified or determined, illustrated as block 306. A type or size of a box or other container for packaging the parcels going to the same address is identified or determined, illustrated as block 308. The parcels going to the same address are then consolidated into the container, illustrated as block 310, and the package is labeled and delivered on a predetermined schedule to the intended recipient, illustrated as block 312.

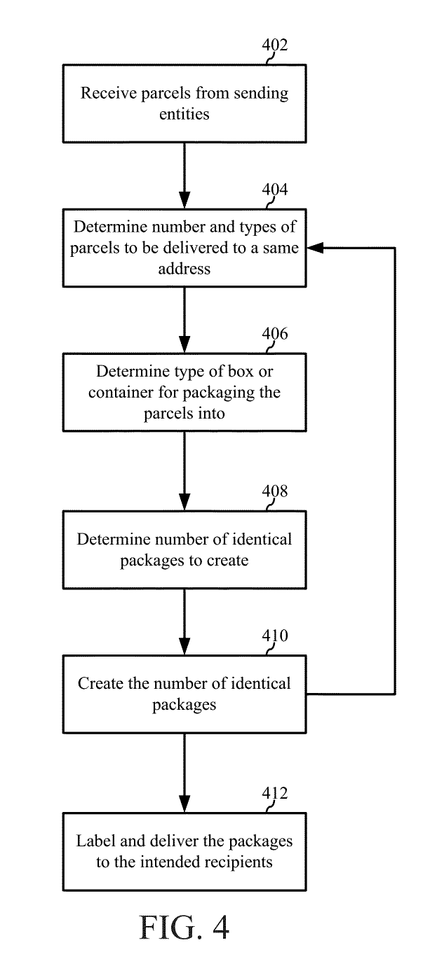

In general, the computing device, such as computing device 200, or the computer program determines how many identical content containers are required, and packaging of the containers commences in an orderly fashion. FIG. 4 illustrates an exemplary method for consolidating and delivering these packages. In block 402, the first entity receives one or more parcels from one or more sending entities. A number and types of the parcels to be delivered to a same address are identified or determined, illustrated as block 404. A type or size of a box or other container for packaging the parcels going to the same address into is identified or determined, illustrated as block 406. The number of identical packages to create containing the same parcels or items is determined, illustrated as block 408. The number of packages is then created, illustrated as block 410.

To fill or package the appropriate number of containers with contents to be delivered, the system and method may take all the addresses of all the intended recipients for each item and determine all the types of containers and contents that are necessary to deliver to each address. Once the determination of how many and the content of the necessary containers, the packing of each independent container commences. For example, empty containers may be placed on a conveyor belt surrounded with the items/parcels to be placed in each different container. Containers with identical contents are labeled and packed as necessary before switching to a next container that may contain more or less items/parcels. This process may be repeated until all the necessary different containers are completed, such as illustrated in FIG. 4 by the arrow connecting blocks 410 and 404. The completed containers/packages are then labeled, stored and then delivered to the intended recipients on a predetermined schedule, illustrated as block 412.

While a conventional delivery system is predicated in delivering an entire area, practically every day. This new more efficient method is designed to purposely use its resources over time. Thus, a driver and the vehicle may cover its predefined route over an entire month or week, saving resources and cost. The system and method may also make sure that packages are created and delivered to an address that has at least a sufficient number of items to make the delivery of the package cost effective. If it is not cost effective, the particular address may not be serviced. For example, and without limitation, the present method and system can collect respective parcels to be delivered to neighborhoods A and B. The containers containing the respective parcels are then temporarily stored. Instead of having the delivery driver repeatedly drive through neighborhoods A and B when parcels for those neighborhoods are received, the drive instead only delivers the containers with the parcels destined for neighborhood A on a first day, and then delivers the containers with the parcels destined for neighborhood B on a second day, based on a predetermined schedule. In such a method and system, the consolidation of a plurality of parcels and delivery of such parcels based on a predetermined schedule ensures efficient delivery, instead of having delivery vehicles delivering packages based on the receipt of such packages.

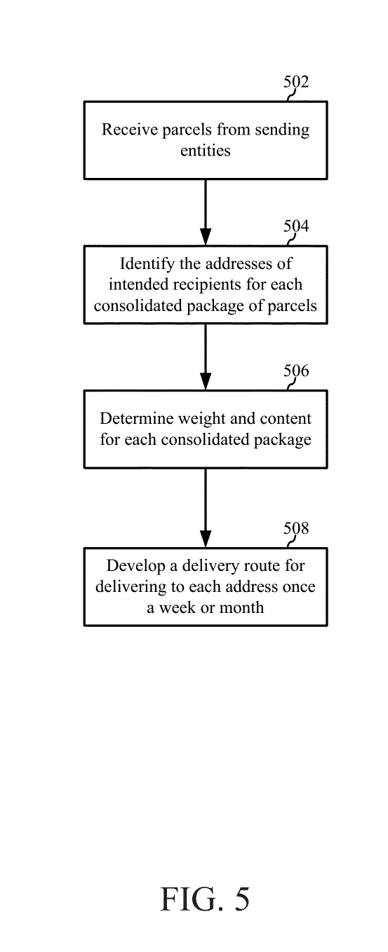

In an aspect, the content and weight of each delivery can be predicted a month in advance, for a more efficient use of resources. FIG. 5 illustrates an exemplary method for delivering the packages. In block 502, the first entity receives one or more parcels from one or more sending entities. Address of intended recipients for each consolidated package containing items/parcels going to the same address is determined, illustrated as block 504. A weight and content for each consolidated package is determined, illustrated as block 506. A delivery route for delivering the consolidated packages to each relevant address once a week or month is developed, illustrated as block 508.

This method of developing a daily delivery route, that includes a different area for each delivery person allows for the route, the content and weight of each delivery to be predicted in advance (such as a week or month), for a more efficient use of resources. In general, the driver visits the same address only once every 30 days, or potentially weekly, for example. The driver does not go back to the same address daily, as a driver for conventional delivery company does every day. This avoids the repetitive daily trips to the same address.

Warehousing may also be more efficient than conventional shipping warehouses. For example, most boxes or containers may be of a same size with few exceptions, thereby allowing for less wasted storage space in the warehouse near the delivery vehicles. Additionally, skids or pallets of similar size can easily be stacked without the need for expensive shelving. These skids or pallets also allow for quick loading of the vehicles using forklifts.

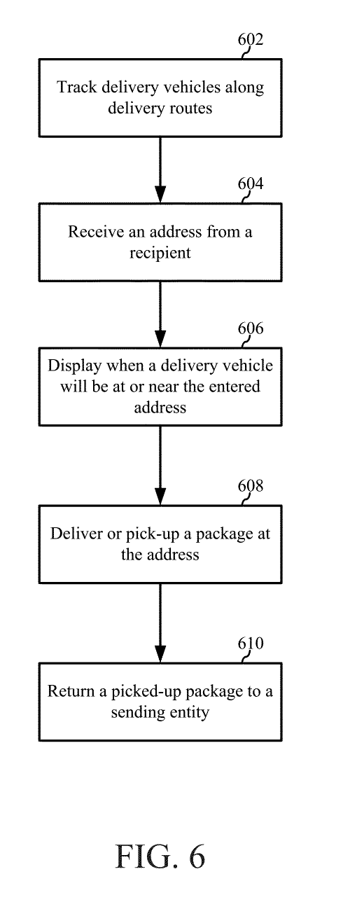

As described above, a recipient may be allowed to view the delivery routes to determine when a delivery will be made or to intersect with the delivery vehicle to return a package. FIG. 6 illustrates an exemplary method for allowing a recipient to return a package. In an aspect, the delivery vehicles may be equipped with GPS or other positioning systems. In block 602, a location of the delivery vehicles along the delivery routes is tracked. A recipient may access the system and enter an address, which is received by, for example, a computing device of the first entity, illustrated as block 604. A time or date of when a delivery vehicle will be at or near the entered address may then be displayed to the recipient, for example, a computing device of the recipient, illustrated as block 606. A present location of the delivery vehicle may also or alternatively be displayed to the recipient.

The delivery vehicle may arrive at the address and deliver or pick-up a package, illustrated as block 608. If a package is picked-up from the recipient, the package may be returned to the sending entity, illustrated as block 610. As an example, a recipient may receive a product intended to be returned after a test or trial period. Using a computing device, the recipient can enter an address such as a home, work or even a restaurant, or another business, and the system and method can pinpoint the best point of intersection between the driver and the consumer's/sender's location at any given address for the return of the product. This enables sending entities to allow a plurality of recipients to test, try, keep or return new products. In general, returned items are brought to the first entity, then shipped back to the sending entity in a bulk shipment, such as, once a month.

Sending entities can take full advantage of demographic factors to have their products sampled with ideal prospects, for a week or a month, to keep or return either 30 or 7 days later. Since the delivery to the recipients include multiple purposes, the delivery and retrieval can be done at a fraction of the cost. At the same time, the same product trial can be conducted with some or every resident of the same zip code to further decrease the cost of economies of scale.

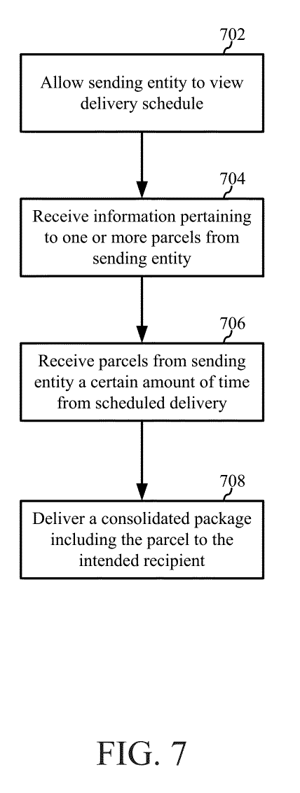

The system and method may allow the sending entities to input information and view information using a computing device. For example, the sending entities may identify, track, coordinate delivery dates, and communicate information about the parcels being sent to the first entity. FIG. 7 illustrates an exemplary method of receiving information from sending entities. In block 702, a sending entity is allowed to view a delivery schedule, for example using a computing device. The sending entity may also input information pertaining to one or more parcels being sent by the sending entity, and the first entity may receive the information, illustrated as block 704. For example, a sending entity may desire to send a parcel to the first entity that is perishable or should be sent to a recipient within a certain amount of time. In this example, the sending entity can obtain scheduled shipment dates from the first entity, and ensure the parcel is received by the first entity and shipped to a recipient within the correct time period, illustrated as block 706. The first entity may then deliver a consolidated package containing the parcel to the intended recipient, illustrated as block 708.

Generally, aspects of the systems and methods disclosed herein can include, and may be implemented, within a number of different devices and computer systems, including, for example, general-purpose computing systems, server-client computing systems, mainframe computing systems, a cloud computing infrastructure, telephone computing systems, laptop computers, desktop computers, smart phones, cellular phones, personal digital assistants (PDAs), tablet computers, and other mobile devices. The devices and computing systems may have one or more databases and other storage apparatuses, servers, and additional components, for example, processors, modems, terminals and displays, computer-readable media, algorithms, modules, and other computer-related components. The devices and computer systems and/or computing infrastructures are configured, programmed, and adapted to perform the functions and processes of the systems and methods as disclosed herein.

Aspects of the systems and methods disclosed herein may be implemented as a computer implemented method, a system, or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid state memory, flash drive, removable disk, and/or other media.

Communications between components in the systems and methods disclosed herein may be unidirectional or bidirectional electronic communication through a wired or wireless configuration or network. For example, one component may be wired or networked wirelessly directly or indirectly, through a third party intermediary, over the Internet, or otherwise with another component to enable communication between the components. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

Further, aspects of the systems and methods disclosed herein may be performed in different forms of software, firmware, and/or hardware. The aspects may be performed on a single device or may be performed on multiple devices. For example, program modules including one or more components described herein may be located in different devices and may each perform one or more aspects of the present disclosure. Moreover, unless specifically stated any use of the terms first, second, etc. do not denote any order or importance, but rather the terms first, second, etc. are merely used to distinguish one element from another.

Although the systems and methods have been described and illustrated in connection with certain embodiments, many variations and modifications will be evident to those skilled in the art and may be made without departing from the spirit and scope of the disclosure. The discourse is thus not to be limited to the precise details of methodology or construction set forth above as such variations and modification are intended to be included within the scope of the disclosure.

What is claimed is:

1. A method of delivering items, comprising:
receiving a plurality of items from one or more sending entities;
identifying addresses of intended recipients of the items;
creating a package containing more than one item intended to be delivered to a same address; and
delivering the package to the address based on a predetermined schedule.

2. The method of claim 1, wherein the predetermined schedule is once a week or once a month.

3. The method of claim 1, further comprising determining which items are intended to be delivered to the same address.

4. The method of claim 1, further comprising determining a number of identical packages to create; and creating the number of identical packages.

5. The method of claim 1, further comprising developing a delivery route for delivering packages to addresses on the predetermined schedule.

6. The method of claim 1, further comprising receiving an address input from a recipient.

7. The method of claim 6, further comprising allowing the recipient to view when a delivery vehicle will be at or near the input address.

8. The method of claim 7, further comprising picking up a return package from the input recipient.

9. A system for delivering items, comprising:
a server in communication with a network, the server including at least one processor and a memory device including instructions operable to be executed by the at least one processor to perform a set of actions, configuring the processor:
to identify addresses of intended recipients of items received from sending entities;
to determine a number of items to be delivered to a same address;
to determine a number of identical packages to create, each containing items to be delivered to a respective address;
to track a delivery vehicle along a delivery route;
to receive an address input from a recipient desiring to return an item; and
to allow the recipient to view when the delivery vehicle will be at or near the input address to pick up the return item.

10. The system of claim 9, wherein the processor is further configured to determine a container type for packaging the items to be delivered to the same address into.

11. The system of claim 9, wherein the processor is further configured to determine a weight of each package.

12. The system of claim 9, wherein the processor is further configured to generate a delivery schedule and the delivery route for the delivery vehicle.

13. The system of claim 12, wherein the processor is further configured to allow the sending entities to view the delivery schedule.

14. The system of claim 13, wherein the processor is further configured to receive information from the sending entities relating to the items.
